(19) United States
(12) Patent Application Publication
(10) Pub. No.: US 2008/0046626 A1
(43) Pub. Date: Feb. 21, 2008

(54) Semiconductor device and BUS connecting method

(75) Inventors: Masanori Ishizuka, Kawasaki (JP); Toshio Hosoi, Kawasaki (JP)

Correspondence Address: ARENT FOX LLP, 1050 CONNECTICUT AVENUE, N.W., SUITE 400, WASHINGTON, DC, 20036, US

(73) Assignee: FUJITSU LIMITED

(21) Appl. No.: 11/646,385

(22) Filed: Dec. 28, 2006

(30) Foreign Application Priority Data
Aug. 18, 2006 (JP) 2006-223652

(51) Int. Cl. G06F 13/40

(52) U.S. Cl. 710/307

(57) ABSTRACT

A first internal resource has a first register which is accessible from an external bus via an internal bus and has a same data width as that of the internal bus which is larger than that of the external bus. A second internal resource has a second register which has a same data width as that of the external bus and is accessible from the external bus via the internal bus. A bus interface circuit implements a data transmitting operation between the external bus and the internal bus. The bus interface circuit is constituted of a write buffer and a read buffer which have a same data width as that of the external bus and are accessible from the external bus.

### CROSS REFERENCE TO RELATED APPLICATION

This application is based upon and claims the benefit of priority from Japanese Patent Application No. 2006-223652, filed on Aug. 18, 2006, the entire contents of which are incorporated herein by reference.

### BACKGROUND OF THE INVENTION

1. Field of the Invention

The present invention relates to a semiconductor device having mounted together therein an internal resource which has a register having a data width (number of bits) larger than a data width of an external bus and an internal resource which has a register having a same data width as the external bus, and it relates to a bus connecting method of connecting the external bus and the internal bus in the semiconductor device.

2. Description of the Related Art

There is a semiconductor device whose external bus and internal bus have different data widths. For example, in a case where the data width of an external bus is 16 bits and the data width of the internal bus is 32 bits, the semiconductor device may be configured to access all bits (32 bits) of a register at once depending on an internal resource connected to an internal bus. Japanese Unexamined Patent Application Publication No. 2000-132501 and others disclose a technique to handle such a case.

FIG. 1 shows a conventional semiconductor device. FIG. 2A and FIG. 2B show register mapping of an internal resource in a semiconductor device. The conventional semiconductor device DEV is constituted of internal resources RSC1, RSC2, an internal bus BUSI (32 bits) and a bus interface circuit BIF. The internal resource RSC1 is constituted of a plurality of registers (32 bits). To the registers of the internal resource RSC1, addresses are assigned by register mapping as shown in FIG. 2A. The internal resource RSC2 is constituted of a plurality of registers (16 bits). To the registers of the internal resource RSC2, addresses are assigned by register mapping as shown in FIG. 2B.

The internal bus BUSI activates/deactivates an internal ready signal /RDYI based on an internal address signal ADI supplied from the bus interface circuit BIF (control unit CU), an internal read signal /RDI and an internal write signal /WRI, and performs write access/read access using an internal data signal DI [31:0] to a register as an access target in the internal resources RSC1, RSC2.

The bus interface circuit BIF is constituted of a control unit CU and a buffer unit BU.

The control unit CU activates/deactivates an external ready signal /RDYE, the internal address signal ADI, the internal read signal /RDI, the internal write signal /WRI and a control signal of the buffer unit BU (including buffer write signals WRBR, WRBW and selection signals /SELR, /SELW) based on an external address signal ADE, an external read signal /RDE and an external write signal /WRE supplied from an external bus BUSE (16 bits).

The buffer unit BU is constituted of a read buffer BUFR (16 bits), a gate circuit GR, a write buffer BUFW (16 bits) and a gate circuit GW. The read buffer BUFR accepts an internal data signal DI [31:16] supplied from the internal bus BUSI in response to activation of the buffer write signal WRBR supplied from the control unit CU, and outputs the accepted signal to the gate circuit GR. The gate circuit GR outputs the output signal of the read buffer BUFR as an external data signal DE [15:01 during activation of the selection signal /SELR supplied from the control unit CU.

The write buffer BUFW accepts an external data signal DE [15:0] supplied from the external bus BUSE in response to activation of the buffer write signal WRBW supplied from the control unit CU, and outputs the accepted signal to the gate circuit GW. The gate circuit GW outputs the output signal of the write buffer BUFW as an internal data signal DI [31:16] during activation of the selection signal /SELW supplied from the control unit CU.

FIG. 3 shows an operation during an external write access in the conventional semiconductor device. FIG. 4 shows a data flow during an external write access in the conventional semiconductor device. Note that the operation shown in FIG. 3 is an operation during a write access from the external bus BUSE to a register to which an address A is assigned in the internal resource RSC1. Further, in FIG. 4, a bold arrow designated (C1) shows a data flow in a cycle C1 of FIG. 3, and a bold arrow designated (C2) shows a data flow in a cycle C2 of FIG. 3.

In the cycle Cl, the external bus BUSE sets the external address signal ADE to the address A and sets the external data signal DE [15:0] to data D (A), and activates the external write signal /WRE to low level. Along with this, the control unit CU deactivates the external ready signal /RDYE to high level, and activates the buffer write signal WRBW for the buffer unit BU (write buffer BUFW) to high level. Accordingly, the write buffer BUFW accepts the external data signal DE [15:0] set to the data D (A) (FIG. 4 (C1)). Then, the external bus BUSE deactivates the external write signal /WRE to high level, and thereafter the control unit CU activates the external ready signal /RDYE to low level.

In the cycle C2, the external bus BUSE sets the external data signal DE [15:0] to data D (A+2) and activates the external write signal /WRE to low level. Accompanying this, the control unit CU sets the internal address signal ADI to the address A and activates the internal write signal /WRI to low level, and activates the selection signal /SELW for the buffer BU (gate circuit GW) to low level. Accordingly, the gate circuit GW outputs the output signal of the write buffer BUFW set to the data D (A) as the internal data signal DI [31:16] (FIG. 4 (C2)). Simultaneously, the buffer unit BU outputs the external data signal DE [15:0] set to the data D (A+2) as the internal data signal DI [15:0] (FIG. 4 (C2)). Accordingly, the internal bus BUSI writes the data D (A), D (A+2) to the register to which the address A is assigned in the internal resource RSC1. In accordance with the write, the internal bus BUSI deactivates the internal ready signal /RDYI to high level. Along with the deactivation, the control unit CU deactivates the external ready signal /RDYE to high level, and thereafter, deactivates the internal write signal /WRI to high level. Further, the external bus BUSE deactivates the external write signal /WRE to high level after the external ready signal /RDYE is deactivated. Thereafter, the control unit CU activates the external ready signal /RDYE to low level.

FIG. 5 shows an operation during an external read access in the conventional semiconductor device. FIG. 6 shows a data flow during an external read access in the conventional semiconductor device. Note that the operation shown in FIG. 5 is an operation during a read access from the external bus BUSE to a register to which an address A is assigned in the internal resource RSC1. Further, in FIG. 6, a bold arrow designated (C1) shows a data flow in a cycle C1 of FIG. 5, and a bold arrow designated (C2) shows a data flow in a cycle C2 of FIG. 5.

In the cycle C1, the external bus BUSE sets the external address signal ADE to an address A and activates the external read signal /RDE to low level. Accordingly, the control unit CU sets the internal address signal ADI to the address A and activates the internal read signal /RDI to low level. Along with this, the internal bus BUSI reads, after deactivating the internal ready signal /RDYI to high level, data D (A), D (A+2) from the register to which the address A is assigned in the internal resource RSC1, and sets the internal data signals DI [31:16], DI [15:0] to the data D (A), D (A+2). Thereafter, the control unit CU deactivates the external ready signal /RDYE to high level, and activates the buffer write signal WRBR for the buffer unit BU (read buffer BUFR) to high level. Along with this, the read buffer BUFR accepts the internal data signal DI [31:16] set to the data D (A) (FIG. 6 (C1)). Simultaneously, the buffer unit BU outputs the internal data signal DI [15:0] set to the data D (A+2) as the external data signal DE [15:01 (FIG. 6 (C1)). Then, the control unit CU deactivates the internal read signal /RDI to high level, and thereafter, the internal bus BUSI activates the internal ready signal /RDYI to low level. Further, the external bus BUSE deactivates the external read signal /RDE to high level after the external ready signal /RDYE is deactivated. Thereafter, the control unit CU activates the external ready signal /RDYE to low level.

In the cycle C2, the external bus BUSE activates the external read signal /RDE to low level. Along with the activation, the control unit CU deactivates the external ready signal /RDYE to high level, and activates the selection signal /SELR for the buffer unit BU (gate circuit GR) to low level. Accordingly, the gate circuit GR outputs an output signal of the read buffer BUFR set to the data D (A) as the external data signal DE [15:0] (FIG. 6 (C2)). Then, the external bus BUSE deactivates the external read signal /RDE to high level after the external ready signal /RDYE is deactivated. Thereafter, the control unit CU activates the external ready signal /RDYE to low level.

Since the data width of the register in the internal resource RSC2 is 16 bits, inherently, the external bus BUSE should be able to complete an access to a register in the internal resource RSC2 in one cycle without using the read buffer BUFR or the write buffer BUFW. However, in the semiconductor device DEV of FIG. 1, two cycles are always needed for the external bus BUSE to complete the access to a register in the internal resource RSC2, thereby generating one unnecessary cycle.

Further, when the external bus BUSE writes same data (for example, data having “0” in all bits) to all the registers in the internal resource RSC1, the external access efficiency is very low since upon every access to each of the registers, a cycle is needed to store data in the write buffer BUFW.

### SUMMARY OF THE INVENTION

An object of the present invention is to improve the external access efficiency in a semiconductor device having mounted together therein an internal resource which has a register having a data width larger than a data width of an external bus and an internal resource which has a register having a same data width as that of the external bus.

In an aspect of the present invention, a semiconductor device is constituted of an internal bus, a first internal resource, a second internal resource and a bus interface circuit. The internal bus has a data width larger than a data width of the external bus. The first internal resource has a first register which has a same data width as that of the internal bus and is accessible from the external bus via the internal bus. The second internal resource has a second register which has a same data width as that of the external bus and is accessible from the external bus via the internal bus. The bus interface circuit implements a data transmitting operation between the external bus and the internal bus (that is, connects the external bus and the internal bus). The bus interface circuit is constituted of a write buffer and a read buffer both of which have a same data width as that of the external bus and are accessible from the external bus.

When the external bus makes a write access to the first register, the bus interface circuit implements a data transmitting operation from the external bus to the internal bus using an external bus's write access to the write buffer, and when the external bus makes a read access to the first register, it implements a data transmitting operation from the internal bus to the external bus using an external bus's read access to the read buffer. When the external bus makes a write access to the second register, the bus interface circuit implements a data transmitting operation from the external bus to the internal bus without using the external bus's write access to the write buffer, and when the external bus makes a read access to the second register, it implements a data transmitting operation from the internal bus to the external bus without using the external bus's read access to the read buffer.

Specifically, when the external bus makes a write access to the first register, after storing in the write buffer data supplied from the external bus by an external bus's write access to the write buffer, the bus interface circuit transmits, to the internal bus, as write data for the first register, data supplied from the external bus and data in the write buffer at once in a next cycle. When the external bus makes a read access to the first register, the bus interface circuit transmits data in the read buffer to the external bus in a next cycle by an external bus's read access to the read buffer, after transmitting a part of read data in the first register supplied from the internal bus to the external bus and storing in the read buffer a rest of the read data in the first register supplied from the internal bus. When the external bus to makes a write access to the second register, the bus interface circuit transmits to the internal bus data supplied from the external bus as write data for the second register without using the write buffer. When the external bus makes a read access to the second register, the bus interface circuit transmits to the external bus read data in the second register supplied from the internal bus without using the read buffer.

Further, when the first internal resource is constituted of a plurality of the first registers, and the external bus makes a write access to the plurality of first registers for same data, after storing in the write buffer data supplied from the external bus by an external bus's write access to the write buffer in a first cycle, the bus interface circuit transmits, to the internal bus, as write data for the first register to be accessed, data supplied from the external bus and data in the write buffer at once in subsequent cycles. Preferably, the bus interface circuit is constituted of a read-write buffer which functions as both of the write buffer and the read buffer.

According to the semiconductor device as above, the write buffer and the read buffer in the bus interface circuit are accessible from the external bus, and the external bus's write access (read access) to the write buffer (read buffer) is used only during the external bus's write access (read access) to the first register, so that the external bus's write access (read access) to the second register can be completed within one cycle. Further, when the first internal resource is constituted of a plurality of the first registers, and the external bus makes a write access to the plurality of first registers for same data, data is stored in the write buffer only in a first cycle, so that the external bus's write access to the plurality of the first registers for the same data can be completed in a smaller number of cycles. Thus, the external access can be completed in a minimum number of cycles, which can contribute largely to improvement in the external access efficiency.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a block diagram showing a conventional semiconductor device;

FIG. 2A and FIG. 2B are explanatory views showing register mapping of an internal resource in a semiconductor device;

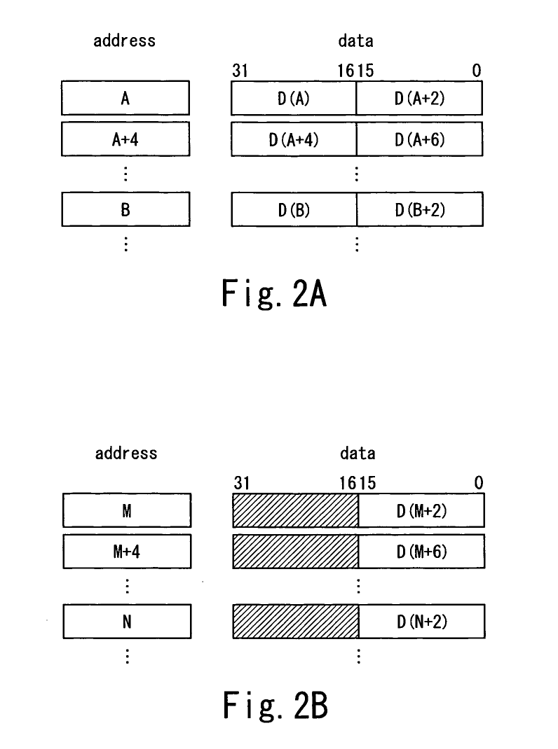

FIG. 3 is a timing chart showing an operation during an external write access in the conventional semiconductor device;

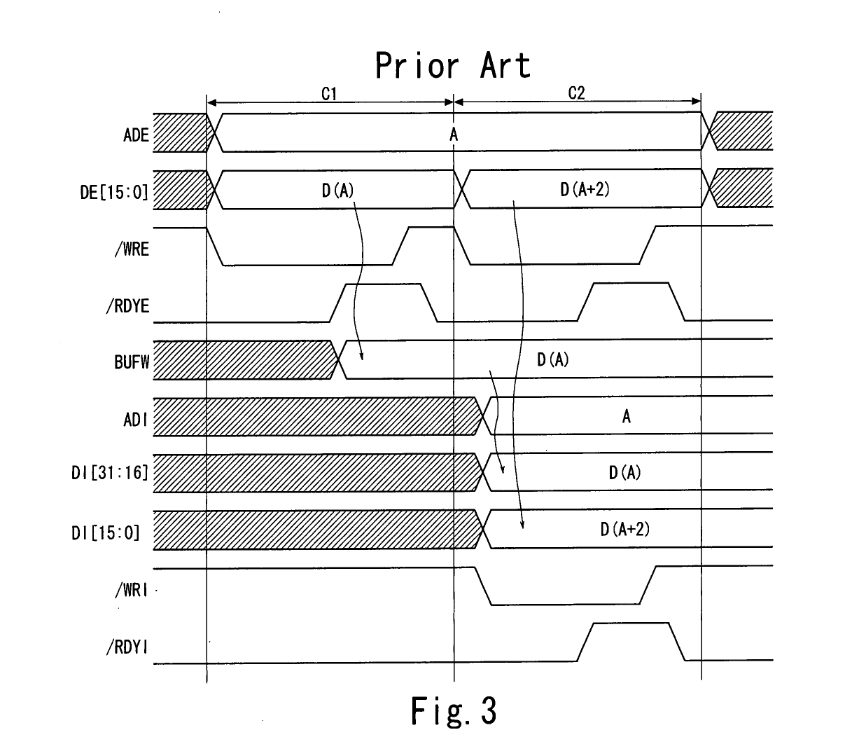

FIG. 4 is an explanatory view showing a data flow during an external write access in the conventional semiconductor device;

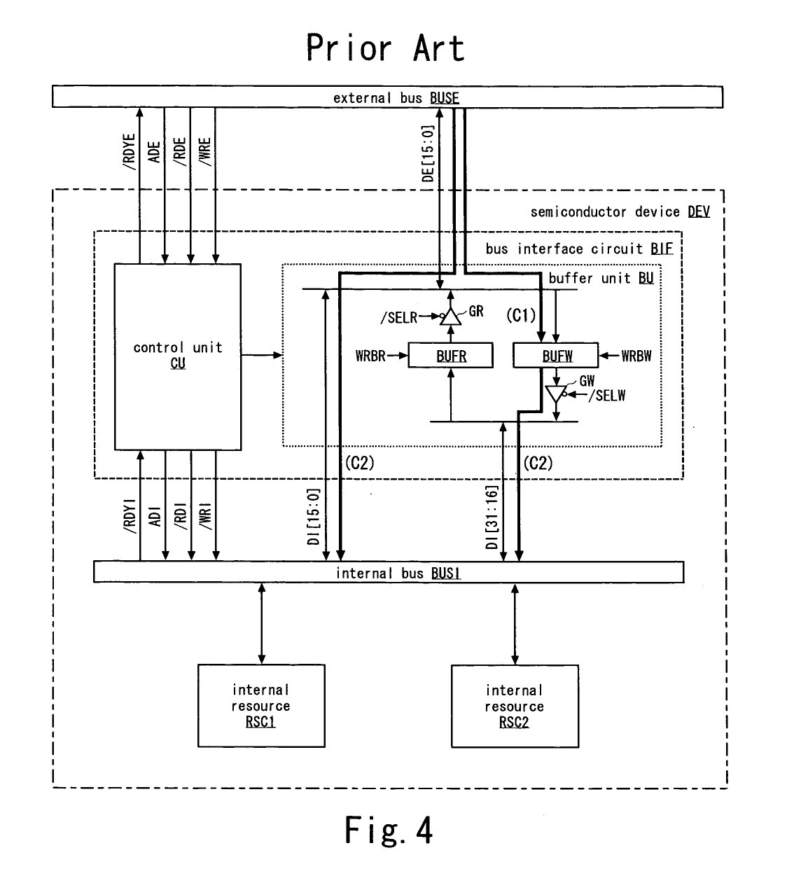

FIG. 5 is a timing chart showing an operation during an external read access in the conventional semiconductor device;

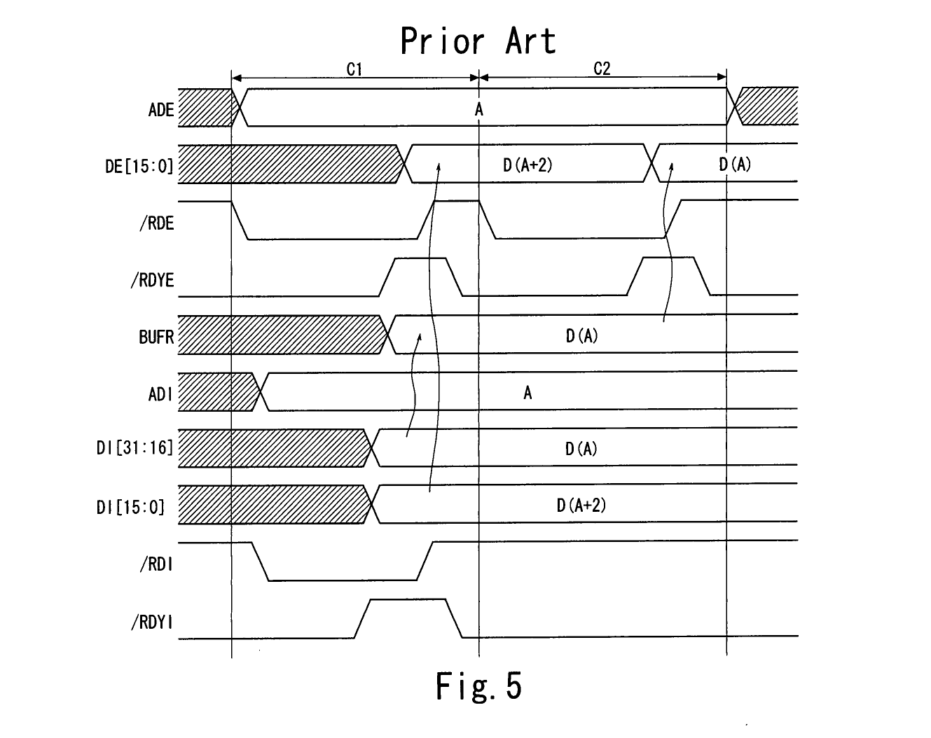

FIG. 6 is an explanatory view showing a data flow during an external read access in the conventional semiconductor device;

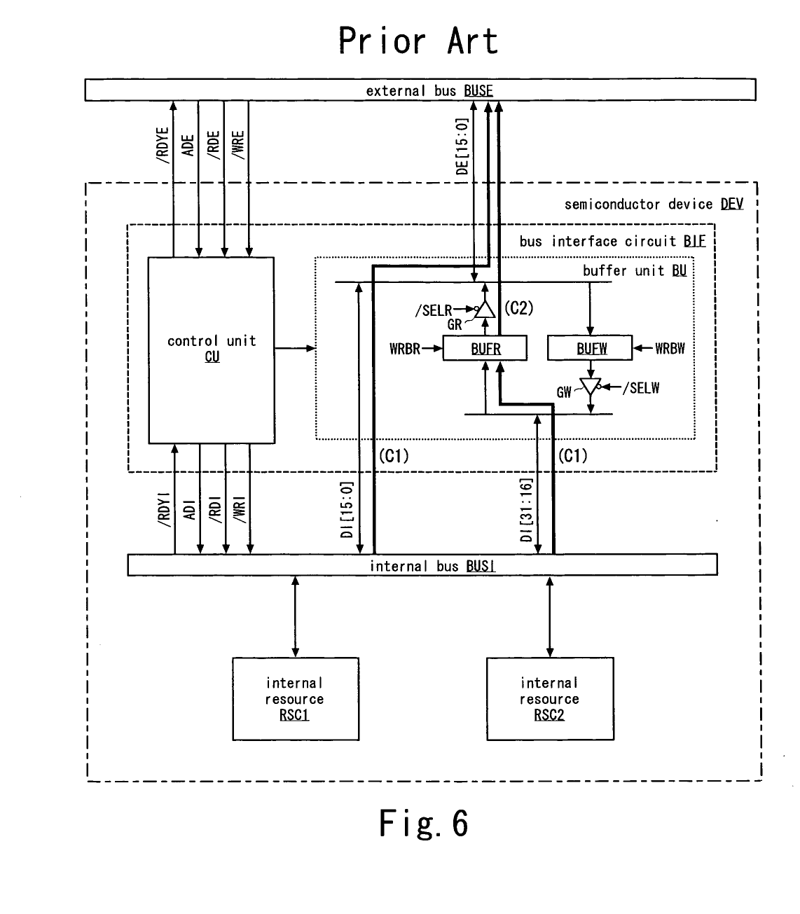

FIG. 7 is a block diagram showing a first embodiment of the present invention;

FIG. 8 is a timing chart showing operations during an external write access in the semiconductor device of FIG. 7;

FIG. 9 is an explanatory view showing a data flow during an external write access in the semiconductor device of FIG. 7;

FIG. 10 is a timing chart showing operations during an external read access in the semiconductor device of FIG. 7;

FIG. 11 is an explanatory view showing a data flow during an external read access in the semiconductor device of FIG. 7; and

FIG. 12 is a block diagram showing a second embodiment of the present invention.

### DESCRIPTION OF THE PREFERRED EMBODIMENTS

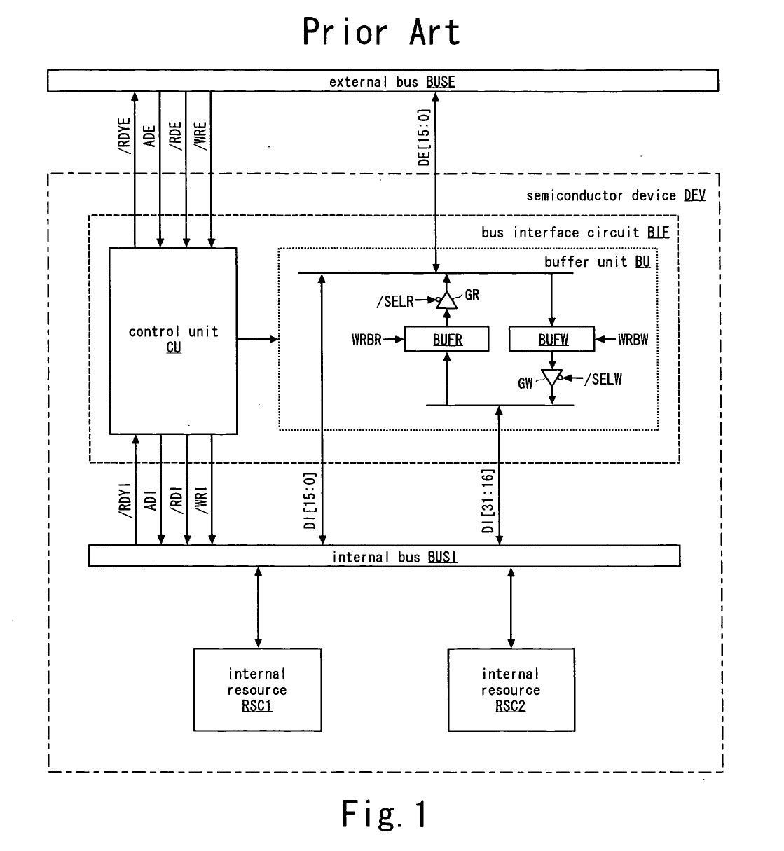

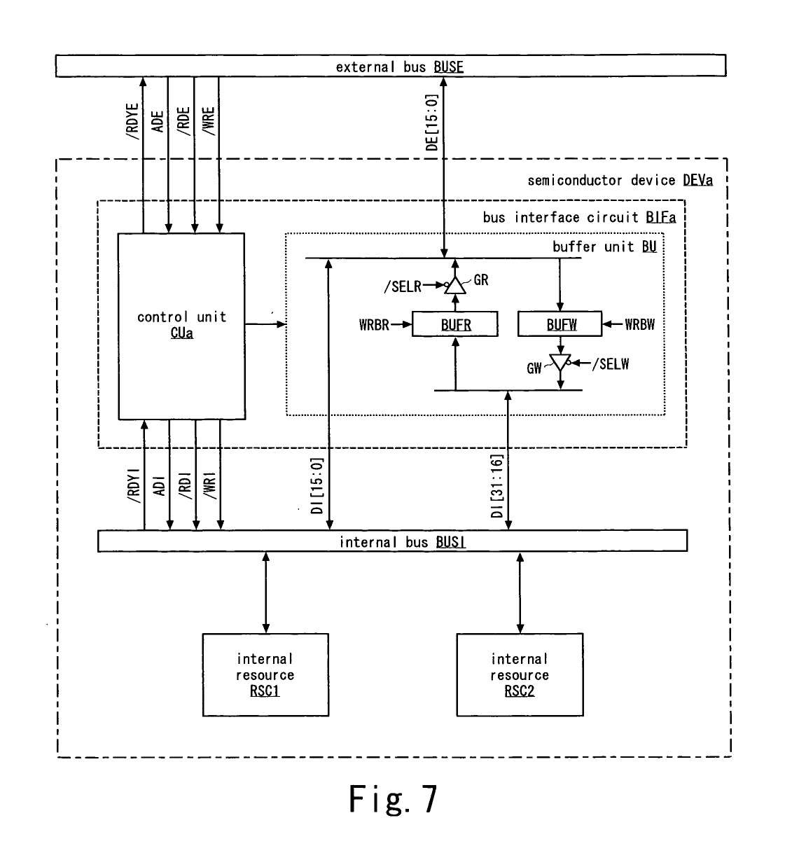

Hereinafter, embodiments of the present invention will be explained using drawings. FIG. 7 shows a first embodiment of the present invention. FIG. 7 is explained below, but for the same elements as those explained with FIG. 1, the same symbols as those used in FIG. 1 are used, and detailed descriptions thereof are omitted. A semiconductor device DEVa of FIG. 7 is constituted by replacing the bus interface circuit BIF in the semiconductor device DEV of FIG. 1 with a bus interface circuit BIFa.

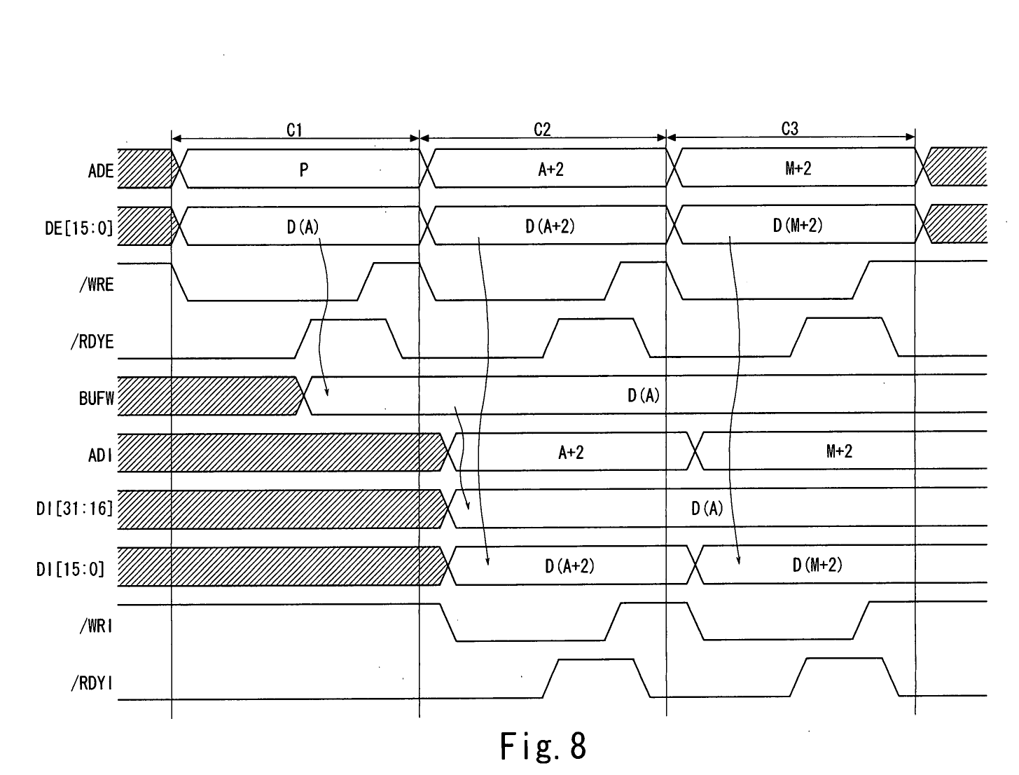

The bus interface circuit BIFa is constituted of a control unit CUa and a buffer unit BU. Note that in the semiconductor device DEVa, a write buffer BUFW of the buffer unit BU is assigned an address P and is accessible from an external bus BUSE. Further, a read buffer BUFR of the buffer unit BU is assigned an address Q and is accessible from the external bus BUSE. The control unit CUa is basically the same as the control unit CU. The difference between the control unit CUa and the control unit CU will be clear by explanations of FIG. 8 to FIG. 11.

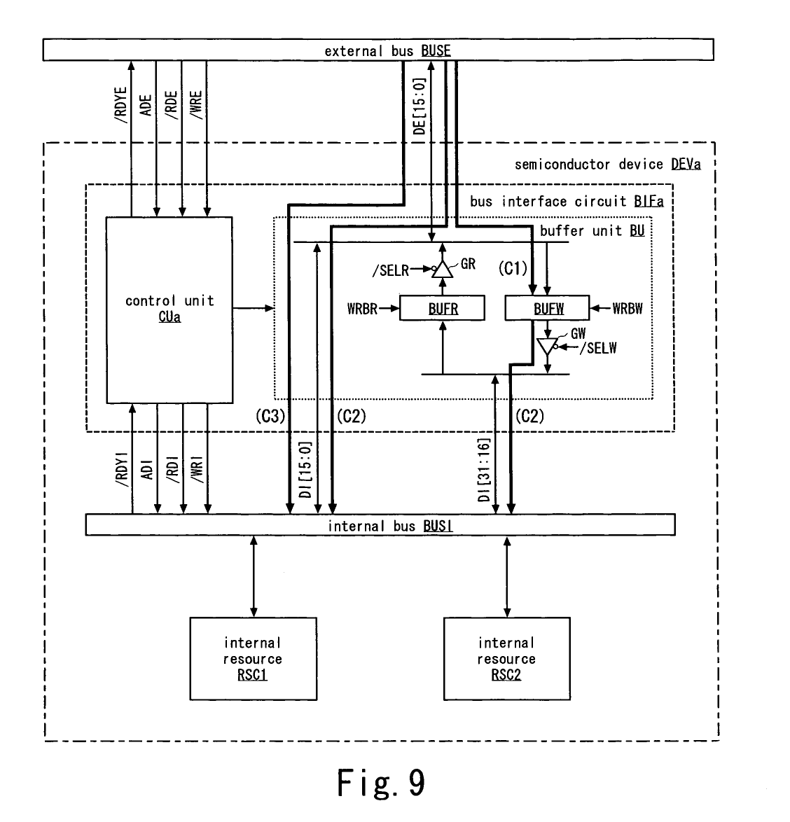

FIG. 8 shows operations during an external write access in the semiconductor device of FIG. 7. FIG. 9 shows a data flow during an external write access in the semiconductor device of FIG. 7. Note that the operations shown in FIG. 8 are an operation during a write access to a register to which an address A is assigned in the internal resource RSC1 from the external bus BUSE (cycles C1, C2) and an operation during a write access to a register to which an address M is assigned in the internal resource RSC2 from the external bus BUSE (cycle C3). Further, in FIG. 9, a bold arrow designated (C1) shows a data flow in the cycle C1 of FIG. 8, a bold arrow designated (C2) shows a data flow in the cycle C2 of FIG. 8, and a bold arrow designated (C3) shows a data flow in the cycle C3 of FIG. 8.

In the cycle C1, the external bus BUSE sets an external address signal ADE to the address P and sets an external data signal DE [15:0] to data D (A), and activates an external write signal /WRE to low level. Accompanying this, the control unit CUa deactivates an external ready signal /RDYE to high level, and activates a buffer write signal WRBW for the buffer unit BU (write buffer BUFW) to high level. Accordingly, the write buffer BUFW accepts external data signal DE [15:0] set to the data D (A) (FIG. 9 (C1)). Then, the external bus BUSE deactivates the external write signal /WRE to high level, and thereafter, the control unit CUa activates the external ready signal /RDYE to low level.

In the cycle C2, the external bus BUSE sets the external address signal ADE to an address A+2 and sets the external data signal DE [15:0] to data D (A+2), and activates the external write signal /WRE to low level. Accompanying this, the control unit CUa sets the internal address signal ADI to the address A+2 and activates the internal write signal /WRI to low level, and activates a selection signal /SELW for the buffer unit BU (gate circuit GW) to low level. Accordingly, the gate circuit GW outputs the output signal of the write buffer BUFW set to the data D (A) as an internal data signal DI [31:16] (FIG. 9 (C2)). Simultaneously, the buffer unit BU outputs the external data signal DE [15:0] set to the data D (A+2) as an internal data signal DI [15:0] (FIG. 9 (C2)). Accordingly, an internal bus BUSI writes the data D (A), D (A+2) to the register to which the address A is assigned in the internal resource RSC1. Corresponding to this, the internal bus BUSI deactivates an internal ready signal /RDYI to high level. Accompanying this, the control unit CUa deactivates the external ready signal /RDYE to high level, and thereafter, deactivates the internal write signal /WRI to high level. Further, the external bus BUSE deactivates the external write signal /WRE to high level after the external ready signal /RDYE is deactivated. Thereafter, the control unit CUa activates the external ready signal /RDYE to low level.

In the cycle C3, the external bus BUSE sets the external address signal ADE to an address M+2 and sets the external data signal DE [15:0] to data D (M+2), and activates the external write signal /WRE to low level. Accompanying this, the control unit CUa sets the internal address signal ADI to the address M+2, and activates the internal write signal /WRI to low level. Simultaneously, the buffer unit BU outputs the external data signal DE [15:0] set to the data D (M+2) as the internal data signal DI [15:0] (FIG. 9 (C3)). Accordingly, the internal bus BUSI writes the data D (M+2) to the register to which the address M is assigned in the internal resource RSC2. Corresponding to this, the internal bus BUSI deactivates the internal ready signal /RDYI to high level. Accompanying this, the control unit CUa deactivates the external ready signal /RDYE to high level, and thereafter deactivates the internal write signal /WRI to high level. Further, after the external ready signal /RDYE is deactivated, the external bus BUSE deactivates the external write signal /WRE to high level. Thereafter, the control unit CUa activates the external ready signal /RDYE to low level.

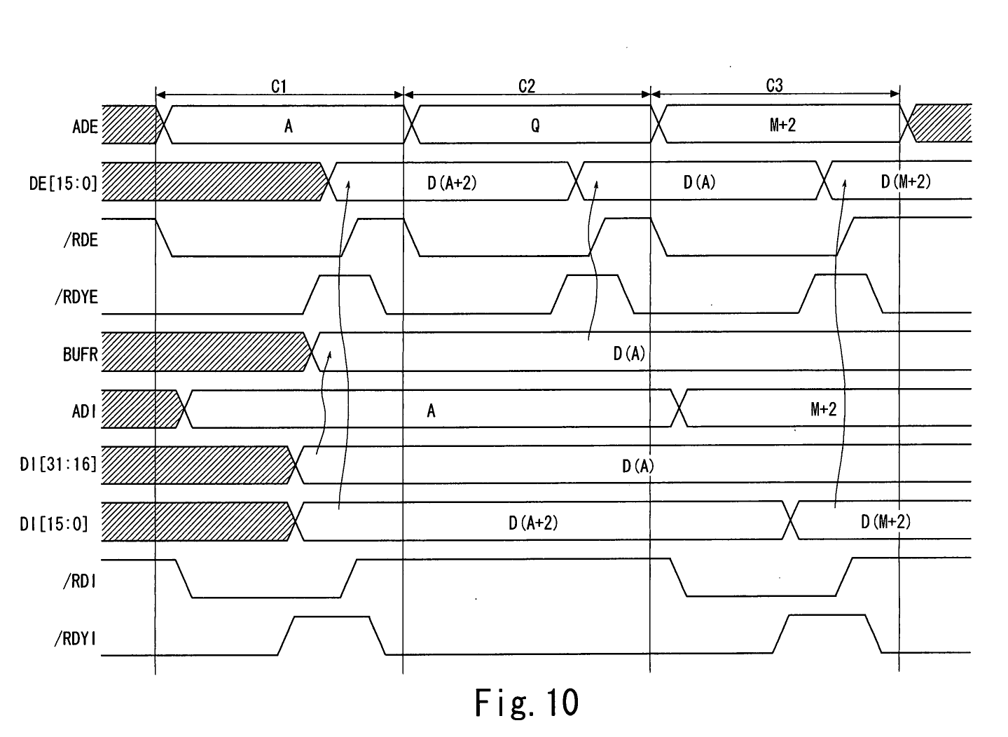

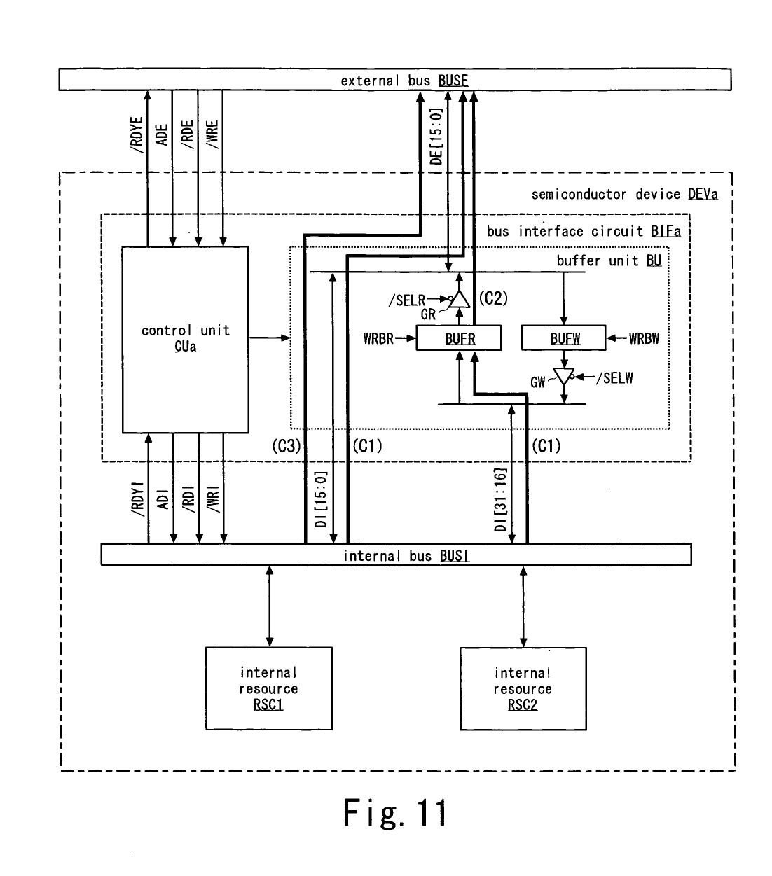

FIG. 10 shows operations during an external read access in the semiconductor device of FIG. 7. FIG. 11 shows a data flow during an external read access in the semiconductor device of FIG. 7. Note that the operations shown in FIG. 10 are an operation during a read access to a register to which an address A is assigned in the internal resource RSC1 from the external bus BUSE (cycles C1, C2) and an operation during a read access to a register to which an address M is assigned in the internal resource RSC2 from the external bus BUSE (cycle C3). Further, in FIG. 11, a bold arrow designated (C1) shows a data flow in the cycle C1 of FIG. 10, a bold arrow designated (C2) shows a data flow in the cycle C2 of FIG. 10, and a bold arrow designated (C3) shows a data flow in the cycle C3 of FIG. 10.

In the cycle C1, the external bus BUSE sets the external address signal ADE to the address A and activates the external read signal /RDE to low level. Accordingly, the control unit CUa sets the internal address signal ADI to the address A and activates the internal read signal /RDI to low level. Accompanying this, after deactivating the internal ready signal /RDYI to high level, the internal bus BUSI reads the data D (A), (D (A+2) from the register to which the address A is assigned in the internal resource RSC1, and sets the internal data signals DI [31:16], DI [15:01 to the data D (A), D (A+2). Thereafter, the control unit CUa deactivates the external ready signal /RDYE to high level and activates a buffer write signal WRBR for the buffer unit BU (read buffer BUFR) to high level. Accompanying this, the read buffer BUFR accepts internal data signal DI [31:16] set to the data D (A) (FIG. 11 (C1)). Simultaneously, the buffer unit BU outputs the internal data signal DI [15:0] set to the data D (A+2) as the external data signal DE [15:0] (FIG. 11 (C1)). Then, the control unit CUa deactivates the internal read signal /RDI to high level, and thereafter, the internal bus BUSI activates the internal ready signal /RDYI to low level. Further, after the external ready signal /RDYE is deactivated, the external bus BUSE deactivates the external read signal /RDE to high level. Thereafter, the control unit CUa activates the external ready signal /RDYE to low level.

In the cycle C2, the external bus BUSE sets the external address signal ADE to the address Q and activates the external read signal /RDE to low level. Accordingly, the control unit CUa deactivates the external ready signal /RDYE to high level and activates a selection signal /SELR for the buffer unit BU (gate circuit GR) to low level. Accompanying this, the gate circuit GR outputs an output signal of the read buffer BUFR set to the data D (A) as the external data signal DE [15:0] (FIG. 11 (C2)). Then, after the external ready signal /RDYE is deactivated, the external bus BUSE deactivates the external read signal /RDE to high level. Thereafter, the control unit CUa activates the external ready signal /RDYE to low level.

In the cycle C3, the external bus BUSE sets the external address signal ADE to the address M+2 and activates the external read signal /RDE to low level. Accordingly, the control unit CUa sets the internal address signal ADI to the address M+2 and activates the internal read signal /RDI to low level. Accompanying this, after deactivating the internal ready signal /RDYI to high level, the internal bus BUSI reads the data D (M+2) from the register to which the address M is assigned in the internal resource RSC2 and sets the internal data signal DI [15:0] to the data D (M+2). Thereafter, the control unit CUa deactivates the external ready signal /RDYE to high level. Simultaneously, the buffer unit BU outputs the internal data signal DI [15:0] set to the data D (M+2) as the external data signal DE [15:0] (FIG. 11 (C3)). Then, the control unit CUa deactivates the internal read signal /RDI to high level, and thereafter, the internal bus BUSI activates the internal ready signal /RDYI to low level. Further, after the external ready signal /RDYE is deactivated, the external bus BUSE deactivates the external read signal /RDE to high level. Thereafter, the control unit CUa activates the external ready signal /RDYE to low level.

In the first embodiment as above, the write buffer BUFW and the read buffer BUFR in the bus interface circuit BIFa are accessible from the external bus BUSE, and the write access (read access) from the external bus BUSE to the write buffer BUFW (read buffer BUFR) is used only during the write access (read access) from the external bus BUSE to a register in the internal resource RSC1, so that the write access (read access) from the external bus BUSE to a register in the internal resource RSC2 can be completed by one cycle. Further, when writing same data to a plurality of registers in the internal resource RSC1, the data may be written to the write buffer BUFW by only a first cycle, so that a write access with the same data from the external bus BUSE to the plurality of registers in the internal resource RSC1 can be completed in a less number of cycles. Thus, the external access can be completed by a minimum number of cycles, which can contribute largely to improvement in efficiency of the external access.

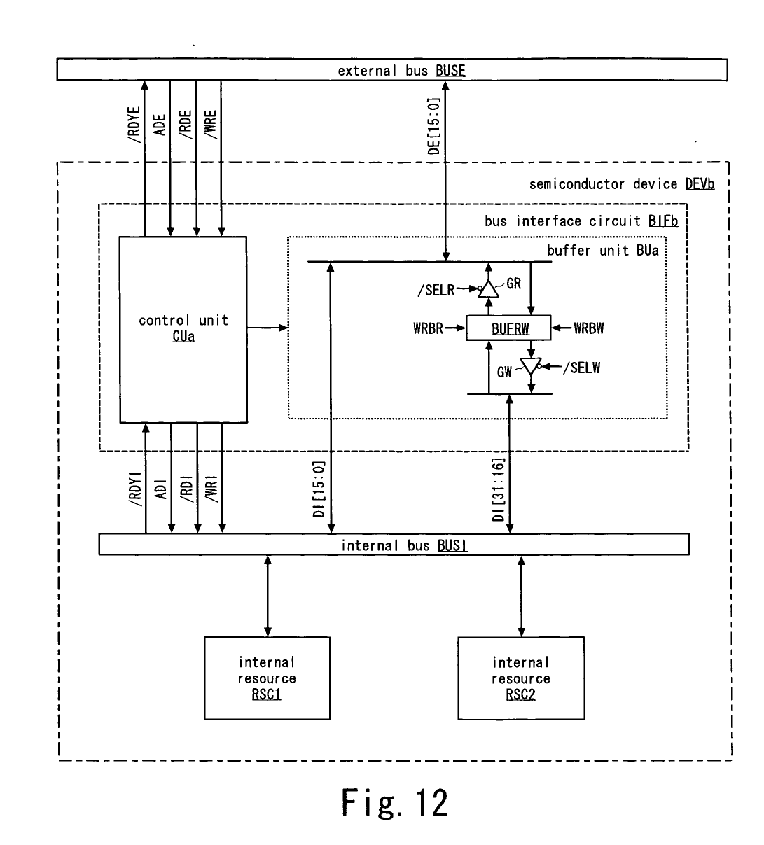

FIG. 12 shows a second embodiment of the present invention. FIG. 12 is explained below, but for the same elements as those explained with FIG. 1 and FIG. 7, the same symbols as those used in FIG. 1 and FIG. 7 are used, and detailed descriptions thereof are omitted. A semiconductor device DEVb of FIG. 12 is constituted by replacing the bus interface circuit BIFa in the semiconductor device DEVa of FIG. 7 with a bus interface circuit BIFb. The bus interface circuit BIFb is constituted of a control unit CUa and a buffer unit BUa. The buffer unit BUa is constituted by replacing the write buffer BUFW and the read buffer BUFR in the buffer unit BU with a read-write buffer BUFRW. The read-write buffer BUFRW functions as both the write buffer BUFW and the read buffer BUFR. Since no contention occurs between the write access and the read access by the external bus BUSE, the normality of the external access will not be lost even when the read-write buffer BUFRW is provided to replace the write buffer BUFW and the read buffer BUFR.

In the second embodiment as above, the same effects as in the first embodiment can be obtained. Further, in the second embodiment, the read-write buffer BUFRW realizes both the functions of the write buffer BUFW and the read buffer BUFR, so that the circuit scale of the bus interface circuit BIFb can be reduced as compared to the bus interface circuit BIFa, which can contribute to reduction in scale of the semiconductor device DEVb.

The invention is not limited to the above embodiments and various modifications may be made without departing from the spirit and scope of the invention. Any improvement may be made in part or all of the components.

What is claimed is:

1. A semiconductor device, comprising:
an internal bus having a data width larger than a data width of an external bus;
a first internal resource having a first register which has a same data width as that of said internal bus and is accessible from said external bus via said internal bus;
a second internal resource having a second register which has a same data width as that of said external bus and is accessible from said external bus via said internal bus; and
a bus interface circuit which implements a data transmitting operation between said external bus and said internal bus, wherein:
said bus interface circuit comprises a write buffer and a read buffer both having a same data width as that of said external bus and being accessible from said external bus;
when said external bus makes a write access to said first register, said bus interface circuit implements a data transmitting operation from said external bus to said internal bus using an external bus's write access to said write buffer, and when said external bus makes a read access to said first register, it implements a data transmitting operation from said internal bus to said external bus using an external bus's read access to said read buffer; and
when said external bus makes a write access to said second register, said bus interface circuit implements a data transmitting operation from said external bus to said internal bus without using the external bus's write access to said write buffer, and when said external bus makes a read access to said second register, it implements a data transmitting operation from said internal bus to said external bus without using the external bus's read access to said read buffer.

2. The semiconductor device according to claim 1, wherein:
when said external bus makes a write access to said first register, after storing in said write buffer data supplied from said external bus by an external bus's write access to said write buffer, said bus interface circuit transmits, to said internal bus, as write data for said first register, data supplied from said external bus and data in said write buffer at once in a next cycle; and
when said external bus makes a read access to said first register, said bus interface circuit transmits data in said read buffer to said external bus in a next cycle by an external bus's read access to said read buffer, after transmitting to said external bus a part of read data in said first register supplied from said internal bus and storing in said read buffer a rest of the read data in said first register supplied from said internal bus.

3. The semiconductor device according to claim 1, wherein:
when said external bus makes a write access to said second register, said bus interface circuit transmits, to said internal bus, data supplied from said external bus as write data for said second register without using said write buffer; and
when said external bus makes a read access to said second register, said bus interface circuit transmits, to said external bus, read data in said second register supplied from said internal bus without using said read buffer.

4. The semiconductor device according to claim 1, wherein:
said first internal resource comprises a plurality of first registers; and
when said external bus makes a write access to the plurality of first registers for same data, after storing in said write buffer data supplied from said external bus by an external bus's write access to said write buffer in a first cycle, said bus interface circuit transmits, to said internal bus, as write data for said first register to be accessed, data supplied from said external bus and data in said write buffer at once in subsequent cycles.

5. The semiconductor device according to claim 1, wherein
said bus interface circuit comprises a read-write buffer which functions as both of said write buffer and said read buffer.

6. A bus connecting method for a semiconductor device which comprises an internal bus having a data width larger than a data width of an external bus, a first internal resource having a first register which has a same data width as that of said internal bus and is accessible from said external bus via said internal bus, and a second internal resource having a second register which has a same data width as that of said external bus and is accessible from said external bus via said internal bus, to connect said external bus and said internal bus, the method comprising the steps of:
providing between said external bus and said internal bus a write buffer and a read buffer both having a same data width as that of said external bus and being accessible from said external bus;
implementing, when said external bus makes a write access to said first register, a data transmitting operation from said external bus to said internal bus using an external bus's write access to said write buffer, and implementing, when said external bus makes a read access to said first register, a data transmitting operation from said internal bus to said external bus using an external bus's read access to said read buffer; and
implementing, when said external bus makes a write access to said second register, a data transmitting operation from said external bus to said internal bus without using the external bus's write access to said write buffer, and implementing, when said external bus makes a read access to said second register, a data transmitting operation from said internal bus to said external bus without using the external bus's read access to said read buffer.

7. The bus connecting method according to claim 6, further comprising the steps of:
when said external bus makes a write access to said first register, transmitting, to said internal bus, as write data for said first register, data supplied from said external bus and data in said write buffer at once in a next cycle, after storing in said write buffer data supplied from said external bus by an external bus's write access to said write buffer; and
when said external bus makes a read access to said first register, transmitting, to said external bus, data in said read buffer in a next cycle by an external bus's read access to said read buffer, after transmitting to said external bus a part of read data in said first register supplied from said internal bus and storing in said read buffer a rest of the read data in said first register supplied from said internal bus.

8. The bus connecting method according to claim 6, further comprising the steps of:
when said external bus makes a write access to said second register, transmitting, to said internal bus, as write data for said second register, data supplied from said external bus without using said write buffer; and
when said external bus makes a read access to said second register, transmitting, to said external bus, read data in said second register supplied from said internal bus without using said read buffer.

9. The bus connecting method according to claim 6, further comprising the step of:
when said first internal resource is constituted of a plurality of first registers, after storing in said write buffer data supplied from said external bus by an external bus's write access to said write buffer in a first cycle, transmitting, to said internal bus, as write data for said first register to be accessed, data supplied from said external bus and data in said write buffer at once in subsequent cycles, when said external bus makes a write access to the plurality of first registers for same data.

10. The bus connecting method according to claim 6, further comprising the step of:
providing between said external bus and said internal bus a read-write buffer which functions as both of said write buffer and said read buffer.
